(19) United States
(12) Patent Application Publication
(10) Pub. No.: US 2008/0124696 A1
(43) Pub. Date: May 29, 2008

(54) EMPIRICAL DEVELOPMENT OF LEARNING CONTENT USING EDUCATIONAL MEASUREMENT SCALES

(76) Inventors: Ronald L. Houser, Damascus, OR (US); Rhonda M. Boyd, Wilsonville, OR (US); G. Gage Kingsbury, Portland, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/553,370

(22) Filed: Oct. 26, 2006

(51) Int. Cl. G09B 3/00

(52) U.S. Cl. 434/350

(57) ABSTRACT

Embodiments of the present invention provide empirical development of educational content that is appropriate for students based on their performance on an educational assessment, where the educational assessment is created using items calibrated to at least one educational measurement scale. Other embodiments may be described and claimed.

### TECHNICAL FIELD

Embodiments of the present invention relate to the field of education and educational assessment, and more particularly, to empirical development of educational content that may be appropriate for students based on their performance on an educational assessment, where the educational assessment may be created using items calibrated to at least one educational measurement scale.

### BACKGROUND

Educators' primary responsibility to their students is to provide an educational environment rich enough to enable each student to reach his or her academic potential. Public schools are required to serve all students in their attendance areas and, therefore, have little control over students' preparation for beginning the learning experience, for influences outside the school or for student capacity for learning. They must tailor the instructional program to meet the needs of each student. Certainly information about beginning academic achievement levels may be an extremely important element in the process of tailoring an instructional program for each student, but how much a student grows academically may be the most important indicator of the strength of educational programs.

Raw scores based on student responses to a relevant series of tasks (test questions) have little meaning until they are placed in the context of some known distribution of scores (usually referenced by the word “norm”). Norm based scores, however, are not appropriate metrics to compute growth. Growth, using norm based scores, may only represent growth if a student changes his/her relative position within the distributions identified in the norming process. The use of norms to represent student scores is the foundation of classical test theory.

Classical test theory employs normative distributions to create meaning from test scores. Each score may be interpreted by its distance from the average score (norm) in standard deviation units. Since test scores are interpreted based on averages (means) of the group that took the test, score interpretation may change if the characteristics of the group taking the test change. Normatively based test scores are thus said to be “sample dependent.” For example, if a group of students took a fourth grade reading test and established an average score of 45 with a standard deviation of 10, students with a score of 50 would have a standard (norm) score of 0.5 (45-50/10 or ½ of a standard deviation above the mean). If a new group of (better prepared) students took the same test with a mean of 55 and a standard deviation of 12, a student with a score of 50 would have a standard score of −0.42 (55-50/12). This would tell a teacher how different the student is from average, but would not represent the growth a student has made from the previous assessment.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates an exemplary scale for an educational subject area in accordance with various embodiments of the present invention;

FIGS. 2 and 3 illustrate networking arrangements for linking suitable for use to practice various embodiments of the present invention;

FIG. 4 illustrates a sparse matrix calibration model suitable for use to practice various embodiments of the present invention;

FIG. 5 illustrates a graph suitable for analyzing field test item responses in accordance with various embodiments of the present invention; and

FIGS. 6 and 7 illustrate exemplary reports of Information Data Statements in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide empirical development of educational content that may be appropriate for students based on their performance on an educational assessment, where the educational assessment may be created using items calibrated to at least one educational measurement scale.

As used herein, an item refers to a task presented to an examinee to which the examinee provides a response. The task may range from simple to very complex. For example, the response may be as simple as making a choice from a specific number of options to a totally open ended response that may be many paragraphs in length. It is through this task-response pairing that psychometricians may measure a human trait (latent trait) that is not directly observable through some physical means. By sampling a number of these task-response observations, a stronger measure of the latent trait may be developed.

Scalar based measurement offers an alternative to classical test theory to make meaning of scores by their relative position on the scale. Once the scale has been created, a student's score may be compared to a previous score on the same scale to determine growth. Norms, categorical performance levels and instructional descriptors may be added to increase the utility of the scale scores, but they are not necessary to compute the most valuable comparison, specifically, growth.

A set of statistical models used in scalar measurement is generally referred to as item response theory (IRT). Instead of analyzing samples of students taking groups of items (tests), IRT analysts look at the response of each student to each item. Patterns of these responses are used to build scales that may be used to measure the ability of individuals and the difficulty of items that are from different samples. This makes it possible to compare students from different times and places and to look at the relative difficulty of questions even if they did not appear on the same test.

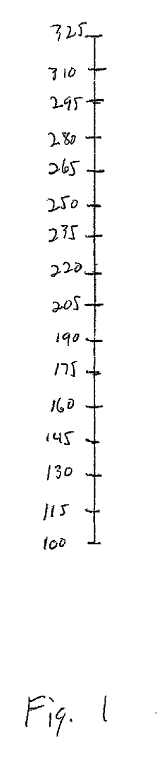

Generally, in accordance with various embodiments of the present invention, a scale ties student abilities with items for assessment within an educational subject area. An exemplary scale is illustrated in FIG. 1. In accordance with various embodiments, the items for assessment generally comprise a plurality of questions. A plurality of scales for a plurality of educational subject areas are developed and maintained. Each scale may be developed based upon a plurality of questions and responses over a period of time, generally a long period of time, i.e., a period of years. In accordance with various embodiments, new items are tied to the scale by presenting the new items (termed “field test” items) to groups of students with known abilities tied to the scales in order to determine where on the scale each item belongs. Thus, an item having a scale score of 190 should be answered correctly by a certain percentage of students that are rated as having an ability of 190 within the corresponding educational subject matter area. In accordance with various embodiments of the present invention, the percentage is 50%. Items are maintained within item banks for the various subject areas and are arranged corresponding to scale score.

More particularly, a psychometric model may be selected that serves as the mathematical basis for developing the scales. Many psychometric models exist that may be used. In accordance with various embodiments, a one-parameter logistic model may be used. In accordance with various embodiments, the Rasch model may be used. The Rasch model provides features that are beneficial in developing and maintaining the scales. It provides an equal interval scale. If the units on the scale are not equal interval, growth scores may have different meanings depending on scalar position. IRT measurement scales have equal intervals throughout the range of the scale in the following sense: For any two values of ability on the scale, the odds ratio of success on a given item equals the odds ratio of the two scores. Additionally, a one-unit change in theta (θ) difference results in a 2.718 unit change in the odds for success. These properties are true for any point on the scale. Equal intervals (such as a yard stick) facilitate the interpretation of growth scores since scalar position does not have to be taken into account when computing the magnitude of the growth.

For the Rasch model, the probability (P) of a student getting a correct answer, given the student's ability, is:

$$P \text{(} X = 1 \vert θ ) = P ( θ ) = \frac{{e}^{θ}}{{e}^{b} + {e}^{θ}}$$

where θ is examinee ability, b is item difficulty

$$Q ( θ ) = 1 - P ( θ ) = \frac{{e}^{b}}{{e}^{b} + {e}^{θ}}$$

The odds for success (O) on a single item are:

$$O = \frac{P ( θ )}{Q ( θ )} = \frac{{e}^{θ}}{{e}^{b}} and ln O = θ - b$$

For any two examinees (A and B) the ratio of odds of success on a single item is:

$$\frac{{O}_{A}}{{O}_{B}} = \frac{{e}^{{θ}_{A}}}{{e}^{{θ}_{B}}} and ln \frac{{O}_{A}}{{O}_{B}} = {θ}_{A} - {θ}_{B}$$

For any two items (1 and 2) the ratio of odds of success for a single examinee is:

$$\frac{{O}_{1}}{{O}_{2}} = \frac{{e}^{{b}_{1}}}{{e}^{{b}_{2}}} and ln \frac{{O}_{1}}{{O}_{2}} = {b}_{1} - {b}_{2}$$

For examinees, a one unit difference in ability may be associated with a 2.718 (or e¹) factor of odds for success. These relationships hold throughout the scale. The formulation above may be revisited to show that IRT scales may be treated as equal interval only in this limited sense. There may be no implication about growth intervals or rates of attainment on scales in accordance with embodiments of the present invention. That is, the expectation that students will make the same amount of growth each year may be unwarranted.

Because the Rasch model needs to estimate only one parameter (in accordance with various embodiments of the present invention, the difficulty parameter, also referred to as the item calibration), it may be the psychometric model that has the greatest potential to develop a scale that may be stable across time. If the scale drifts from one point in time to the next, it may dramatically reduce its usefulness in computing growth.

The Rasch model generally needs a smaller number of student responses to each item to calibrate the item, in comparison to other models. In accordance with various embodiments, each item may be generally administered (field tested) to about 300 to 400 students before a stable estimate of the item difficulty may be obtained.

Classical test theory calculates item difficulty by computing the percent correct for each item. This means that item difficulty may be totally dependent on the particular sample (or norming group) of students to which the item is administered. If it is given to a different set of students, the item difficulty may be different. It changes with each administration of the item. The Rasch model estimates of item difficulty are sample-independent. In other words, no matter what the achievement levels of the students used in computing the Rasch item difficulty parameter, the resultant value will be stable within estimation error. This means that once a stable estimate of the Rasch item difficulty is obtained through field testing, the difficulty may be used as a basis for computing scale scores with any group of students. One limitation to this sample independent characteristic is that the calibration sample for an item should provide good information around the point of inflection in the model. This is the point on the theta (θ) scale where there is a 50% probability of getting the item correct. It may also be identified as the calibration for that item. If most of the calibrating sample of students answer the item correctly or most answer the item incorrectly, the data will be insufficient to estimate the calibration within a tolerable level of accuracy.

In accordance with various embodiments of the present invention, a further operation in the development of psychometric scales may be to answer the question “Which items hang together psychometrically to represent a latent trait that may be important to the teaching/learning environment?” It generally is difficult to directly measure mathematics or reading ability like one would measure a table or a pole. However, it is generally known how tasks and people behave when a measurement scale exists. For example, longer distances take longer to traverse. If there wasn't a way to measure distance, one might figure out distances by how long it took to walk across them. That is, one would infer the distance scale from observations. In a similar manner, psychometricians infer the existence of “latent traits” from actions that may be observed, i.e., responses to test questions. In the Rasch model, each subject matter scale represents a latent trait with a single dimension. That is, the pattern of observed responses to questions on a test may be determined by an examinee's overall ability in the subject. The pattern of responses to a single question by a group of examinees may be determined by the difficulty of the item. When items do not show the expected pattern, something other than examinee ability may be affecting responses. In accordance with various embodiments, such items are rejected for the purpose of developing scale scores.

The task of developing a cross graded scale is often considered a straight linking design, that is, assessment test 1 may be administered at grade 3 and assessment test 2 may be administered at grade 4 with a set of common items. Using the average of the calibrations of the common items in test 1 and subtracting the average of the calibrations of the same items in test 2 produces a linking constant that may be applied to all of the items in test 2. The result is that the combined set of item calibrations is now all on the same scale. The process may be continued with a different set of items on test 2 with test 3 and so on. This requires one test per grade level. After all of the linking constants are applied, the scale is generally complete.

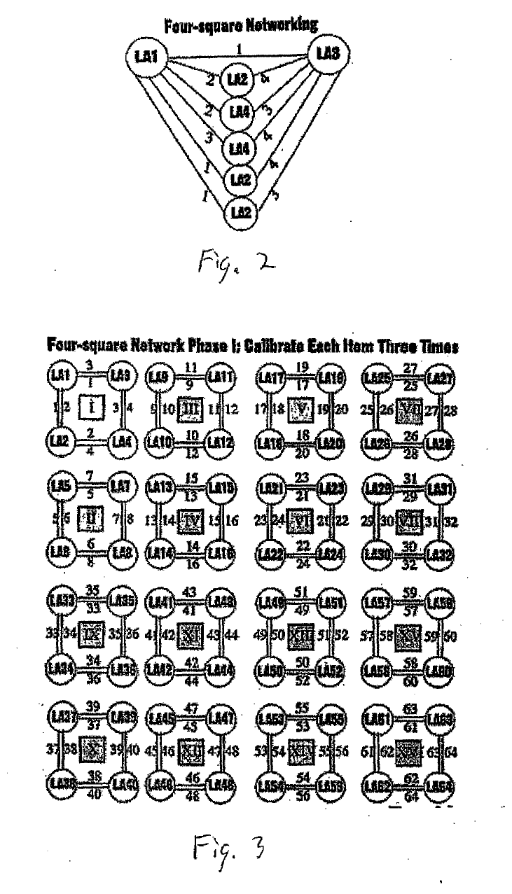

It may be desirable for a good growth scale to be continuous and monotonically increasing. The development of the initial growth scale forms the basis of any subsequent additions or extensions to that scale. In accordance with various embodiments of the present invention and referring to FIGS. 2 and 3, a complex linking design that ensures that the scales are continuous and monotonically increasing may be achieved by using a linking design called a “four-square network” design that results in a minimum of two direct links for each test and three confirming links.

Using a linking design as illustrated in FIGS. 2 and 3, each test link may be double-checked by several other links. In accordance with various embodiments, a triangulation model may be used to guide the resolution of observed inconsistencies. If the link between test 1 and test 2 is +4 points and the link between test 2 and test 3 is +2 points, then the link between test 3 and test 1 must be −6 points. In other words, the sum of the links between test 1, to test 2 to test 3 and back to test 1 should sum to 0. If any of the confirming links support this criterion, they are identified as the correct values. If not, the closest value to meet the 0 criteria may be temporarily used. In the entire design of scales, in accordance with various embodiments of the present invention, numerous tests are used and all linked together using the triangulation criteria. The final linking values should all sum to 0 in the complex array of inter-linking triangles. Any temporary linking constants are now revised with information from other cross check data up and down the linking design.

In accordance with various embodiments of the present invention, once the scales are developed, the limited pool of items that were a part of the initial scaling development, i.e., the initial tests and corresponding questions, are expanded into a pool large enough to be a resource for developing many different kinds of assessments without changing the nature and character of the original scale. Not only do item banks need to be large enough to enable the development of many different kinds of assessments, but they also need to be continuously updated in order to stay current with new developments in curriculum. Assessment tests are made up of a plurality of items for providing assessments of students with respect to educational subject areas.

In accordance with various embodiments of the present invention, adding items to the pools may be achieved by giving a student taking current assessment tests an “opportunity” to take a second test (10 items, which were all field test items) within one week of the calibrated test. The new items are then calibrated with the original calibrated items as if the students had taken one test. Once all of the items are calibrated, a linking constant may be obtained by computing the average difference between the previously calibrated items and their new calibrations in the field test. This average (linking constant) may then be applied to the field test item calibrations.

In accordance with various embodiments of the present invention, a “fixed parameter model” may also be used to expand a pool of items. This model “fixes” the student achievement estimates in the model using the data from the calibrated test. This means that items may be calibrated one at a time if necessary. It is generally not necessary to solve for both the achievement level of the students and the difficulty of the items at the same time. This makes the addition of new items more reliable and much easier because there was no recalibration of previously calibrated items and no need to compute linking constants. The logic of the fixed parameter method works like this: When a bank of items with known difficulties exists, examinee ability may be calculated from responses to these items. When a set of students with known abilities exists, item difficulty may be calculated by these students' responses as in a sparse matrix method further described herein.

Computerized adaptive testing (CAT) may be made possible by the creation of large banks of items that have demonstrated (field tested) calibrations. A computer may be used in a CAT test to select items from the calibrated bank by a series of rules that identify the most informative items to be presented based on the student's cumulative theta (θ) estimate. A new theta estimate may be computed after a student responds to each question. Starting points are identified by additional information such as the student's previous theta score plus an estimate of growth. No two students are likely to receive the same set of items from the calibrated bank, but all will receive a theta estimate on the same scale. The reliability of the scores will vary depending on the efficiency of the item selection process, the depth of the item banks and the number of items sampled. Computerized adaptive testing may be an extremely efficient assessment system since only the most informative items are chosen for each student dynamically as they respond to each test question. It produces the most reliable scores for each student whether they are lower performing, average or higher performing students as compared to any fixed form assessment with the same number of items.

CAT creates opportunities to add one or more field test items anywhere within a test and not have them count toward the students' scores. (This procedure has the added benefit that students do not know which items are field test items so it may be assumed that their motivation may not be different on the field test items as compared to their motivation on all the other items.) However, it also creates some challenges. Since CAT assessment tests, in accordance with various embodiments, are tailored to each student, no two students are likely to be exposed to the same set of items.

In accordance with various embodiments of the present invention, a sparse matrix calibration model may be used for calibration. Thus, in accordance with various embodiments, to accomplish the selection of appropriate field test items for each individual student, a “preliminary calibration” may be assigned to the item and then employed in the field test item selection process as if it were a real calibration. If this preliminary calibration is far from the “real” calibration that is later determined, an adjustment may be made to the preliminary calibration, and it may be returned to the field test process. Since students generally end up with a highly reliable scale score using CAT selection processes on previously calibrated items, each student's score may be used in the sparse matrix much as in the fixed parameter model.

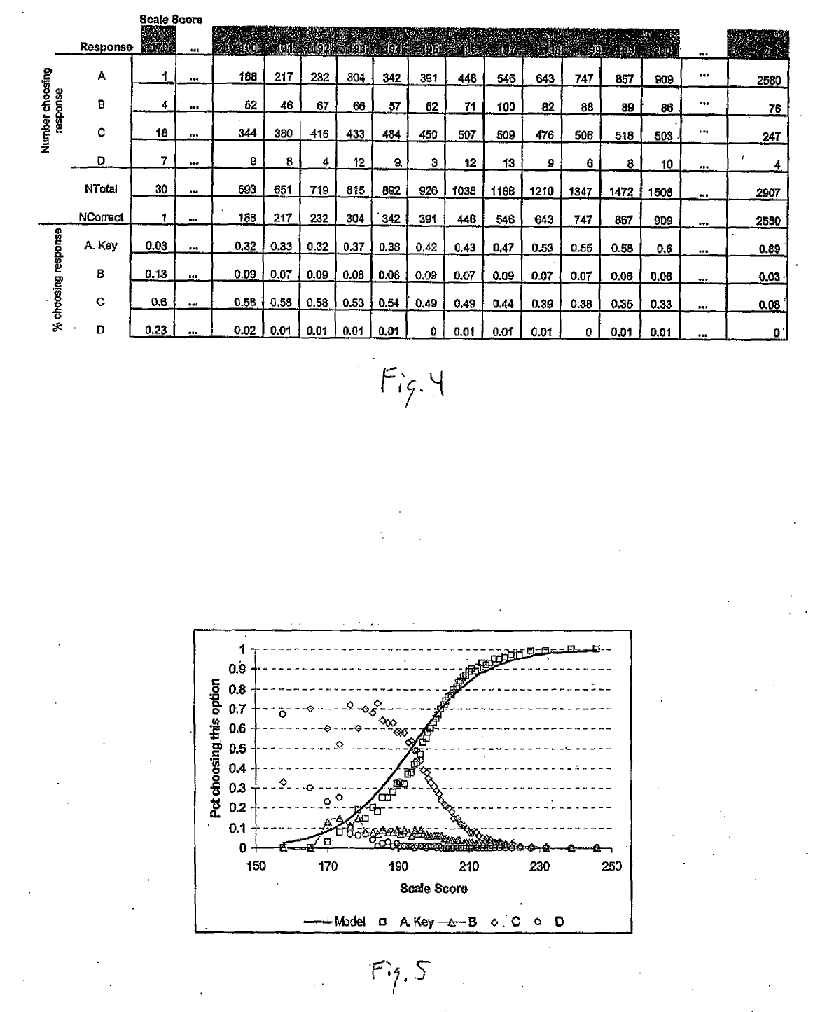

In accordance with various embodiments and referring to FIG. 4, a section of sparse matrix that is a two dimensional array is illustrated. One dimension is a scale score and the second dimension is the item response (e.g. 1, 2, 3, 4 or 5). Each cell in the matrix may be incremented by identifying the single cell representing the student's overall scale score (i.e., the rating of the student's known ability) on the test and their response to the field test item. In accordance with various embodiments, at the point when each item has at least 300 student responses, a maximum likelihood algorithm may be used to estimate the initial calibration. With this initial calibration, students falling below chance performance (in various embodiments, reading 25% and mathematics 20% because in one example, test questions have 4 choice items for reading and 5 choice items for math) are removed from the analysis, and the maximum likelihood estimation algorithm is rerun. In accordance with various embodiments, if there are still more than 300 students, if the model fit statistic (mean square fit) is less than 0.8, and if the item characteristic curve appears to describe how students are performing on the item, the item difficulty from the last estimate may be used as the final calibration. If any of these conditions are not met, then the item may be resubmitted for continued field testing, the preliminary scale score may be adjusted and then returned for field testing, or the item may be classified as an item that does not perform to the Rasch model and eliminated from further development.

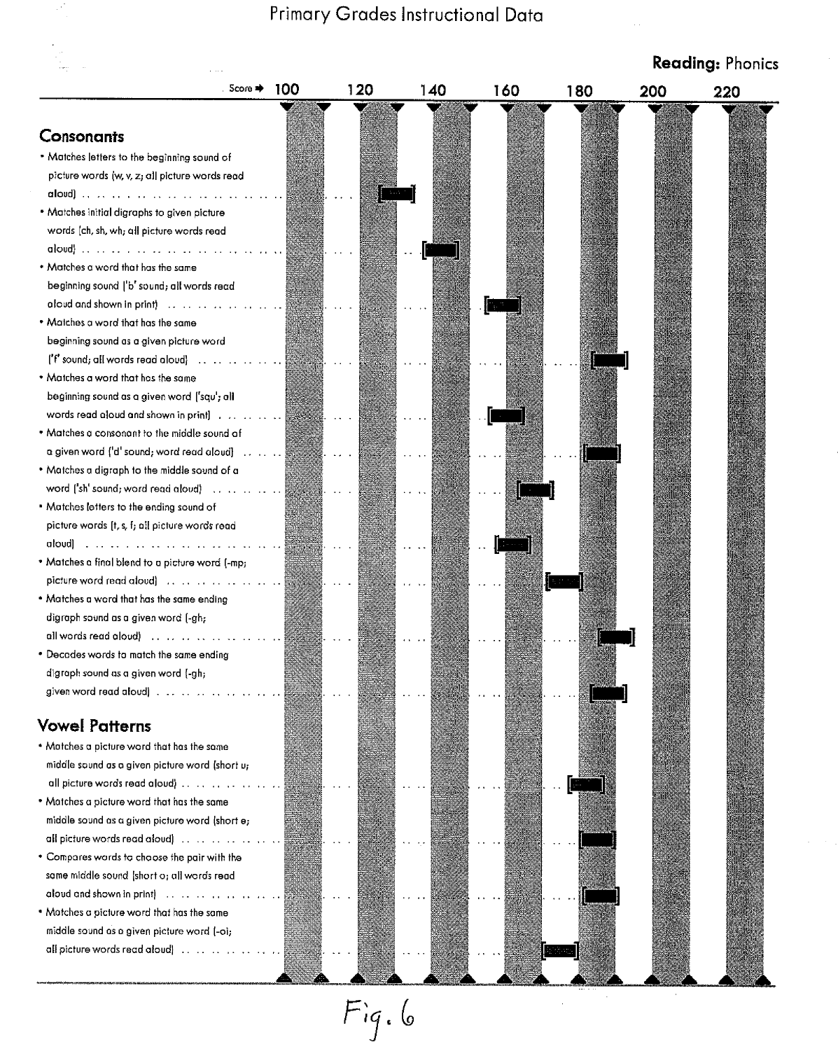

FIG. 4 illustrates a section from a sparse matrix table for a test question with a correct answer of “A.” For each scale score value, the matrix shows the number of students who chose each response. Using these values the percent of students choosing each response may be calculated. As may be seen, very few students chose B or D, but less proficient students thought C was correct. Referring to FIG. 5, the correct response of A forms a curve (represented with squares) similar to that predicted by the Rasch model also represented with squares. The solid line represents expected percents choosing the correct response using the best fitting calibration. In this example, the best calibration is 194 since around 194, approximately 50% selected the correct answer of A.

Since large pools of items take time to develop, often they are built by adding new, uncalibrated items to each test administration, calibrating them and adding them to a pool. However, small item pools often have differential calibration distributions across reported goal categories (Reported goal categories are sub-scores created from a meaningful sub-set of items presented in a test). These pool differentials may result in score bias where there is limited information in immature item pools. In accordance with various embodiments of the present invention, a method of selecting items helps compensate for differential scalar representation between reported goal categories in a computerized adaptive test. This process may also be useful for larger pools where students may tap the same pool for multiple assessments and access to previously seen items has been controlled, thus potentially reducing the number of highly informative items at a particular calibration range for particular reporting categories.

The Rasch model (an item response theory model) addresses the issue of reliability with the concept of item and test information. The model defines the amount of test information in an item as a relationship between the item difficulty (calibration) of the item and the achievement level of the student (θ). The test information of an item may be simply the probability of a correct response multiplied by the probability of an incorrect response:

I(θ)=Pᵢ(θ)Qᵢ(θ)
where I(θ)=the test information of an item for a student with achievement level (θ)
where Pᵢ(θ)=the probability of a correct response for item i
where Qᵢ(θ)=the probability of an incorrect response for item i
   In the following item selection process, the term “test information” employs this mathematical relationship. In a first portion of the method, an initial number of items, for example, the first six items, may be selected without reported goal category consideration and based upon maximizing the amount of test information available for each student at each point in the item selection process. After the first six items, the student's score may often be within a few scale points of their final score. This may allow all of the most informative items in the pool to be used to obtain a good estimate of the student's achievement score before starting the second portion. This initial portion prioritizes the test information characteristics of the pool higher than the reported goal categories.

More particularly, in the first portion of a method in accordance with various embodiments of the present invention, items may be selected by selecting an item randomly from all the items that provide test information of an initial amount of test information, for example, 0.244 or above, for a current momentary achievement estimate. (The maximum amount of test information for dichotomous response data is 0.25. That generally occurs when the probability of a correct response is 0.50 and the probability of an incorrect response is 0.50.) If no items meet the first criteria, an item may be randomly selected from all the items that provide test information of a second amount, for example, 0.210 or above, for the current momentary achievement estimate. If no items meet the second criteria, keep the 0.210 test information criteria, the momentary achievement estimate may be moved down by, for example, a few scale points, such as, for example, 5 points. If no items meet the third criteria, present the single most informative item in the pool. Those skilled in the art will understand that the test information levels of 0.244 and 0.210 are merely exemplary and other test information levels may be used.

While items in the first portion were selected without being constrained by the reported goal categories, a second portion, in accordance with various embodiments, identifies the number of items in each reported goal category and balances them such that at the end of this second portion, the item representation by reported goal category matches a test blueprint by percent. This second portion prioritizes the content standards higher than the test information characteristics of the pool.

In this second portion, the item representation may be summarized for each reported goal category as a result of the first portion. Which reported goal categories have the least representation are identified and item selection on the reported goal categories with the smallest representation identified are prioritized. The most informative item may be identified by selecting the item randomly from all the items that provide test information of 0.244 or above for the current momentary achievement estimate. If no items meet that criteria, select the item randomly from all the items that provide test information of 0.210 or above for the current momentary achievement estimate. If no items meet this criterion, keep the 0.210 test information criteria, but move the momentary achievement estimate down by a few scale points. If no items meet this criterion, present the single most informative item. If there are no items left in the reported goal category, move on to the next reporting category and start the selection process over. Continue selecting items with the smallest reported goal representation until they are equal to the desired weighting. Finally, continue sequentially through the reporting categories until the maximum number of items is reached for this component. Those skilled in the art will understand that the test information levels of 0.244 and 0.210 are merely exemplary and other test information levels may be used.

In a third portion of the method in accordance with various embodiments, differences are identified between the standard error of measurement (SEM) of each reported goal category to a specified “desired” SEM for each reported goal category after the second component is completed. The reported goal category with the largest difference between the desired SEM and the current SEM becomes the target for the first item in this portion. The differences are then recalculated and the reported goal category with the largest difference between the desired SEM and the current SEM is the target of the second item in this component, etc. The end of the test may be determined by all reported goal categories having a SEM equal to, or lower than, the “desired” SEM, or when a maximum number of items have been presented. This third portion prioritizes the reported goal category standard error of measurement.

In the third portion, the most informative item may be identified by selecting the item randomly from all the items that provide test information of 0.244 or above for the current momentary achievement estimate. If no items meet that criteria, select the item randomly from all the items that provide test information of 0.210 or above for the current momentary achievement estimate. If no items meet this criterion, keep the 0.210 test information criteria, but move the momentary achievement estimate down by a few scale points. If no items meet this criterion, present the single most informative item. If there are no items left in the reported goal category, move on to the next reported goal category and start the selection process over. Those skilled in the art will understand that the test information levels of 0.244 and 0.210 are merely exemplary and other test information levels may be used. This item selection process for item banks, in accordance with various embodiments, addresses the development of highly accurate measures with limited item availability.

Thus, in accordance with various embodiments of the present invention, the over-arching model for item bank maintenance is consistency across time. In response to this requirement, recent responses to a representative set of calibrated items on each of the developed scales are analyzed on a periodic basis. Such studies are called calibration or “drift” studies. In accordance with various embodiments, such studies may be conducted about once every three years. In accordance with various embodiments, calibrations developed using the most recent student responses may be compared to corresponding bank calibrations. If the scales are stable, the plots of the two calibrations for all items may be described by a straight line. There may generally be a certain amount of error in the calibrating process, so some variance from an absolute straight line may be expected. In accordance with various embodiments, items that differ by more than a few scale points may be examined to determine if they should remain in the bank.

Thus, the present invention provides methods and systems for developing and maintaining educational item banks within educational subject areas where items, or questions, may be calibrated to allow for assessment of a student's abilities within a subject area using assessment tests made up of items. The items may be calibrated with a stable measurement scale. This may allow for independent assessment of a student's growth within a subject area regardless of when the assessment is made, thereby allowing for an objective assessment.

From a teacher's perspective, a test score should represent student growth, but would have additional meaning if it could provide a direct connection to the next skills that a student needs to learn. The present invention may allow a teacher to obtain information about the specific skills that a student needs to develop based on a test score related to a strong measurement scale.

In accordance with various embodiments of the present invention, instructional data statements (IDS) may be created for each item. Instructional Data Statements are created based on the specific skills and concepts within associated items calibrated via the above described calibration processes and measurement scales for various educational subject areas.

In accordance with various embodiments, an IDS may be a fairly specific statement of a learning skill that is being measured by the total item: the prompt and associated distracters. The prompt may include an item stem and/or question. The distracters are answer options that may be selected along with the correct answer since, in accordance with various embodiments, the question may be a multiple choice question. More particularly, in accordance with various embodiments, the item stem is the actual question posed to the student. The item prompt may be referred to as the information included in the item prior to the stem and answer options. An item may have, for example, a graphic, passage, table, example, diagram, photo, illustration, simulation, and/or manipulative presented to a student and then an actual question or item stem related to the graphic, passage, table, example, or other test element. The information in the item prompt, in accordance with various embodiments, may be described in the IDS. IDSs may have information about the length of the passage, format of a problem, or other aspects. Cognitive complexity of an item may come from the item stem and the distracters. The item prompt may also include, for example, context of the item by way of illustrating one embodiment, which may be additional specificity about the skill or format or functionality in the item. Thus, in summary, items, in accordance with various embodiments of the present invention, include item directions—a prompt (may be a passage, table, graphic, simulation, or other test element), an item stem—question posed to student, and answer options—a correct answer and distracters, where distracters are plausible answer choices, but not correct based on the item stem and/or evidence in the item prompt.

An IDS, in accordance with various embodiments, may contain a verb plus specific language that indicates its cognitive complexity as defined in a reference or treatise. An example of a reference that may be used to define the cognitive complexity is Bloom's Revised Taxonomy of Learning. The use of an appropriate verb in an IDS may not replicate solely the terms that are recommended for each knowledge dimension within a chosen reference or treatise.

An IDS, in accordance with various embodiments of the present invention, generally may include additional information as desired, which further specifies the item to which it pertains (such as, for example, information about the delivery of the item, information relating the item to a measurement scale as described above and/or specific information about the content or context of the item that affects the difficulty of the item with reference to the scale).

An IDS may be written for each item calibrated on a subject-area measurement scale as described above. The item difficulty may thus be independent of the specific population of students that may be encountering this item on a test, and is highly stable, based on the cross-grade level nature of each subject area measurement scale.

An IDS, in accordance with various embodiments, describes the specific and unique nature of the learning as measured by an item with a specific difficulty on a subject area measurement scale as described above. An IDS does generally describe an item and captures specific information related to content, format, and rigor within the item. Furthermore, IDSs may provide instructional and research information to teachers, and may serve as a specific attribute or classification of an item.

In accordance with various embodiments of the present invention, an IDS may serve as a unit level of classification for an item, and generally may not be broken down further into a more specific or discrete statement of learning. It may therefore be used as a representation for an item. The information associated with an IDS is generally fundamental to each item and the skill or learning being measured, and thus, generally does not change. Additionally, IDSs, in accordance with various embodiments, use correct subject area terminology. The terminology that is used is appropriate for use in instruction and may be written based on the needs of the audience.

One example of an IDS, by way of illustrating one embodiment, may include an appropriate verb, then a skill in the distracters/item prompt (this order may be interchanged as desired) with any context or additional description as desired. More particularly, as an example, an IDS may have the following form: “Identifies a word containing a consonant blend and VC-E (verb plus consonant plus silent “e”) when the picture word is read.”

| | | |
|---|---|---|
| identifies | a word containing a | when the picture |
| | consonant blend and VC-E | word is read |
| | (verb plus consonant plus | |
| | silent “e”) | |
| Verb related to first | Specific statement of | Format or context |
| component of cognitive | learning skill | of delivery |
| complexity | | |

### “Measures the length of an object using non-standard units (<, less than 5 units)

| | | |
|---|---|---|
| measures | the length of an object | (<, less than 5 units) |
| | using non-standard units | |
| Verb related to first | Specific statement of | Format or context of |
| component of cognitive | learning skill | delivery |
| complexity | | |

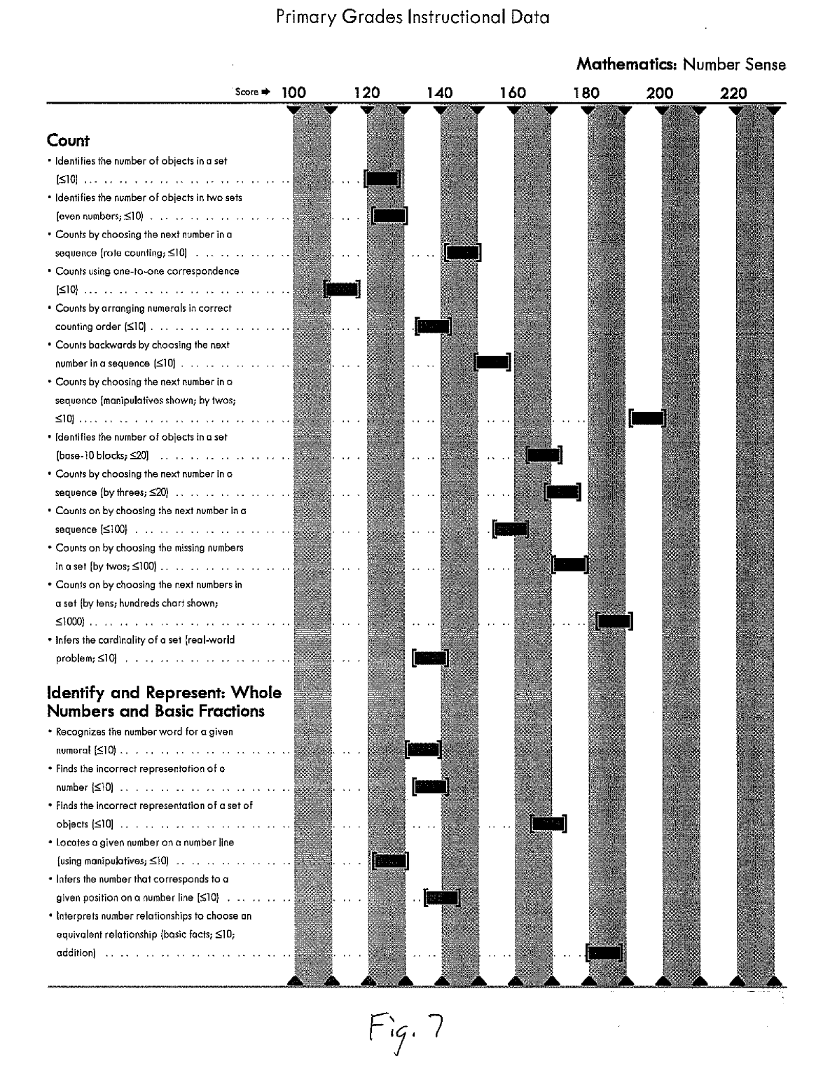

As described above, IDSs may include additional fields for additional information as desired. FIGS. 6 and 7 illustrate exemplary reports of Information Data Statements in accordance with various embodiments of the present invention that include a scale score relating to difficulty.

In accordance with various embodiments of the present invention, classification systems of the same or similar items may be built by sorting on Instructional Data Statements that are identical. Instructional Data Statements are a primary unit of classification for the items, since they are a specific descriptor of the content, format and cognitive complexity of an item or items. In effect, they do represent psychometrically similar items. Only one IDS, in accordance with various embodiments, may describe a given item or group of similar items. Such items are generally not assigned to any other IDS, in accordance with various embodiments. Thus, IDSs may be substantially similar to each other based upon related or similar items. Likewise, an IDS may apply to more than one item when items are substantially similar to each other and are related to each other within an educational subject area.

In accordance with various embodiments of the present invention, Instructional Data Statements may be used to represent items and their difficulty when aligning to state standards, district curriculum, and/or other instructional providers. Items associated or aligned to state standards, district curriculum, and/or instructional providers may be defined or described by the Instructional Data Statements attached to the items.

An IDS (a descriptor for the learning skill of an item or items) generally does not vary. In accordance with various embodiments, each item may be assigned to only one IDS that does not change. Instructional Data Statements may be grouped to align to specific state standards, curriculum, or learning activities based on the purposes of the content alignment. Appropriate items may be associated (through the item descriptors or instructional data statements) to a state's standards or the curricula that are to be measured or assessed, whether by grade level or across grade levels. Instructional Data Statements consequently may become reordered or grouped as related to strand areas, topics, sub-topics, grade level objectives, grade level indicators, cross grade level benchmarks, cognitive rigor of standards, or other similar materials, based upon the purposes of the content alignment of items to a state's standards, a district's curriculum, or other reference. Thus, in accordance with various embodiments, completely different, yet functional hierarchical classification systems of items may be created by reordering topics or concepts within an item classification index on the basis of alignment to a specific state's standards, a district curriculum, or other references as may be seen below.

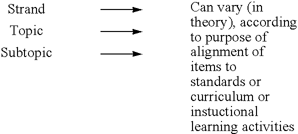

Instructional Data Statements may therefore serve as more than a simple attribute of an item, because they may be grouped for unique alignment purposes into unique classifications of items that represent the content and organization of a specific state's standards, for whatever level of information within a state's standards is meaningful.

Because of calibration and scaling processes as described herein in accordance with various embodiments of the present invention, the item data that are related to each IDS may provide empirical evidence of the associated difficulty of specific skills and concepts. Continued study of the item data associated with IDSs may allow for the unique ability to group, rank, and order specific skills and concepts via the items and the subject-area measurement scales. This information may provide empirical evidence, over time, as to how various sub-skills and concepts increase in difficulty. This ability to order skills and concepts based on empirical data may inform the greater educational community with regard to designing standards and curriculum that support improved student learning.

Since the set of skills represented by items with the same IDS is known, the test results may provide teachers with information about the skills in which a student needs instruction. Since the difficulty of the items is known, the test results may provide teachers with information about which skills will challenge a student without causing them to be frustrated. The test results and associated Instructional Data Statements enable specific instruction that may be tailored to the needs of individual students.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method of developing an educational item bank, the method comprising:
selecting a mathematical model to develop at least one scale of test items relating to measurement of student abilities with respect to at least one area of an educational subject;
obtaining a plurality of responses to a plurality of test items in order to determine a level of difficulty for the test items;
applying the plurality of responses to the mathematical model to determine the at least one scale;
obtaining a plurality of responses to at least one field item from a plurality of students of known ability with respect to the at least one scale; and
calibrating the responses with respect to the at least one scale in order to add the at least one field item to the educational bank.

2. The method of claim 1, wherein the mathematical model is based upon an item response theory model.

3. The method of claim 2, wherein the mathematical model is based upon a Rasch model.

4. The method of claim 1, wherein the plurality of items and their corresponding responses are grouped together based upon a latent trait within the at least one area of an educational subject.

5. The method of claim 4, wherein multiple scales are developed and maintained corresponding to different areas of the educational subject.

6. The method of claim 1, wherein calibrating the responses with the at least one scale in order to add the at least one field item to the educational bank comprises using a sparse matrix calibration index.

7. The method of claim 1, further comprising assigning a preliminary calibration to the at least one field item.

8. The method of claim 1, further comprising periodically analyzing a plurality of recent responses to a group of calibrated items in order to determine stability of the at least one scale.

9. The method of claim 8, wherein periodically analyzing a plurality of recent responses to a group of calibrated items in order to determine stability of the at least one scale comprises comparing the plurality of responses to a previous analysis of the group of calibrated items.

10. The method of claim 9, wherein the previous analysis corresponds to an analysis immediately preceding a current analysis.

11. The method of claim 10, wherein periodically analyzing a plurality of recent responses to a group of calibrated items in order to determine stability of the at least one scale comprises analyzing a plurality of recent responses to a group of calibrated items in order to determine stability of the at least one scale every three years.

12. The method of claim 1, further comprising creating an instructional data statement for each test item.

13. The method of claim 12, wherein creating an instructional data statement for each test item comprises creating an instructional data statement for each test item where the instructional data statement comprises a prompt, an item stem and answer options.

14. The method of claim 13, wherein creating an instructional data statement for each test item comprises creating an instructional data statement for each test item where the instructional data statement further comprises information relating to the difficulty of the test item based upon calibration of the test item to the at least one scale.

15. The method of claim 14, wherein creating an instructional data statement for each test item comprises creating an instructional data statement for each test item where the instructional data statement further comprises information relating to at least one of a skill to which the test item relates, a format of the test item, and functionality of the test item.

16. The method of claim 15, further comprising creating educational classification systems comprising test items that are substantially similar by sorting on instructional data statements that are substantially the same or substantially similar.

17. A system of empirically developed and maintained educational item banks comprising:
at least one scale developed by a plurality of responses to a plurality of test items within an educational subject area using a mathematical model;
a plurality of test items related to the educational subject area organized into a pool of test items in an educational item bank, each test item having a scale score based upon the at least one scale; and
field test items that are provided to a plurality of students of known ability with respect to the at least one scale, wherein the field test items become test items and are added to the educational item bank based upon responses provided by the plurality of students and calibration of the responses with respect to the at least one scale.

18. The system of claim 17, wherein the calibration of responses is achieved with a sparse matrix calibration model.

19. The system of claim 17, wherein the system comprises a plurality of scales, each scale corresponding to an educational subject area and the system comprises an educational item bank and field test items for each educational subject area.

20. The system of claim 17, further comprising an instructional data statement corresponding to each test item.

21. The system of claim 20, wherein the instructional data statement comprises a prompt, an item stem and answer options.

22. The system of claim 21, wherein the instructional data statement further comprises information relating to the difficulty of the test item based upon calibration of the test item to the at least one scale.

23. The system of claim 22, wherein the instructional data statement further comprises information relating to at least one of a skill to which the test item relates, a format of the test item, and functionality of the test item.

24. The system of claim 23, wherein some instructional data statements are substantially identical to each other.

25. A method comprising:
providing a scale of difficulty;
providing a plurality of test items calibrated with respect to the scale of difficulty;
creating an instructional data statement for each test item, each instructional data statement including information relating to the item's difficulty with respect to the scale of difficulty.

26. The method of claim 25, wherein creating an instructional data statement for each test item comprises creating an instructional data statement for each test item where the instructional data statement comprises a prompt, an item stem and answer options.

27. The method of claim 26, wherein the instructional data statement further comprises information relating to at least one of a skill to which the test item relates, a format of the test item, and or functionality of the test item.

28. The method of claim 27, further comprising creating educational classification systems comprising test items that are substantially similar by sorting on instructional data statements that are substantially the same or substantially similar.

29. The method of claim 25, further comprising modifying instructional data statements based upon different educational standards and/or curriculum while maintaining the calibration of the test item with respect to the scale of difficulty.
